(19) United States
(12) Patent Application Publication
(10) Pub. No.: US 2012/0105799 A1
(43) Pub. Date: May 3, 2012

(54) Eyeglass System and Method

(76) Inventor: Brett B. Stewart, Austin, TX (US)

(21) Appl. No.: 13/283,852

(22) Filed: Oct. 28, 2011

Related U.S. Application Data
(60) Provisional application No. 61/407,958, filed on Oct. 29, 2010.

(51) Int. Cl. G02C 11/00

(52) U.S. Cl. 351/158; 351/178

(57) ABSTRACT

A shield that can be coupled to an eyeglass frame. The shield includes a sheet of material that can extend between the eyeglass frame and a user's face during use. The sheet of material includes an insertion edge that couples to a shield mount channel of the eyeglass frame and a contact edge that can be in contact or in near contact with a user's face during use. The shield can inhibit the evaporation of moisture from a user's eye region during use.

### PRIORITY DATA

This application claims benefit of priority to U.S. Provisional Application Ser. No. 61/407,958, titled “Eyeglass System and Method”, filed Oct. 29, 2010, whose inventor was Brett B. Stewart.

### BACKGROUND OF THE INVENTION

1. Field of the Invention

This invention relates to eyewear, and more particularly, to eyeglass devices used to retain moisture at or near the eye region of a user.

2. Description of the Relevant Art

The eye requires that it be continuously covered by natural tears produced by the eye. Tears bathe the eye, washing out dust and debris and keeping the eye moist. They also contain enzymes that neutralize the microorganisms that colonize the eye. Tears are essential for good eye health, and thus eyes constantly produce enough lubricating tears if they are healthy.

A normal tear film has at least three components. One component of the tear film is called the oily layer and is produced by the meibomian glands at the margin of the eyelid. This component helps produce a smooth tear film and prevents it from evaporating too quickly. Another component is called the aqueous layer, which is the watery layer that washes away debris from the eye's surface and is produced by the lacrimal gland. This is what is typically thought of as tears. The third component is called the mucous layer and is composed of mucous produced by the conjunctiva or the clear covering of the eye tissues. The mucous layer allows the normal tear film to stick to the surface of the eye. The eyelid acts to smooth the tear film over the eye's surface each time a person blinks to produce a smooth optical surface and clear vision.

Keratoconjunctivitis sicca, typically referred to as “Dry Eyes”, is a multifactorial disease of the tears and ocular surface that results in symptoms of discomfort, visual disturbance, and tear film instability with potential damage to the ocular surface. It is accompanied by increased osmolarity of the tear film and inflammation of the ocular surface. The condition typically includes inflammation of the eye's cornea and conjunctiva. A person having Dry Eyes typically experiences a number of common symptoms that can include stinging or burning, scratchiness, excessive mucous in or around the eyes, reduced tolerance to smoke or wind, difficulty wearing contact lenses, and possibly over compensation in the form of excessive tearing. People who have Dry Eyes typically do not have a smooth and regular tear film, often resulting in blurry vision caused by the lack of a smooth tear film.

As people age, the normal production of tears begins to slow down. Even though Dry Eyes can occur in men and women, Dry Eyes most commonly occurs in women approaching and after menopause. Dry Eyes can be a naturally occurring medical condition, or may be a result of certain procedures and medications, or other external factors. Dry Eye can be caused by some systemic diseases such as Sjogen's Syndrome and can be a result of taking many common over the counter medications as well as prescription medications.

Laser-Assisted in situ Keratomileusis (LASIK) surgery and similar techniques, such as RK (radial keratotomy), are common procedures that are performed to correct vision. Some patients may experience Dry Eyes after their surgery. This is especially true if there was tendency toward dry Eyes before the procedure. During the LASIK procedure, a thin layer of tissue is created, called a flap, under which the actual laser energy is applied to reshape the cornea to correct nearsightedness, farsightedness, and astigmatism. Anatomically, when the flap is created, the very fine cornea nerves may be severed as part of the LASIK procedure. This is a normal part of the procedure. These nerves, however, are required to “signal” the lacrimal gland to produce tears, and this may not occur after the nerves are severed. Patients may develop Dry Eyes days, months, or even years after having the LASIK procedure.

There are several diagnostic tests that eye care providers may use to help diagnose Dry Eyes. One test is called a Schirmer tear test and involves placing a small strip of filter paper under the lower eyelid. This test measures the actual rate of tear film production. A second test is called Tear Film Break-Up Time and involves placing a small amount of fluorescent dye in your tears and observing the patterns of dryness of the tear film on the eye's surface. A third test is called a Lactoferrin Assay which can measure the amount of lactoferrin in your tears indicating whether a Dry Eye is present.

Dry Eye syndrome is an ongoing condition that is typically not cured, but the accompanying dryness, scratchiness and burning can be managed. There have been many methods to treat Dry Eyes. These include the use of tear duct punctal plugs to help retain a greater amount of tears that are produced, certain dietary supplements, as well as prescription medications, such as Restasis (cyclosporine in a castor oil base) which interferes with inflammatory processes and appears to stimulate natural tear film production. Temporary or permanent silicone tear duct plugs in the lacrimal (tear) ducts, may help to keep tears in the eye from draining away as quickly. Practitioners also prescribe artificial tears, which are lubricating eye drops that may alleviate the dry, scratching feeling, and some patients use generic over-the-counter types of eye-drops to reduce the irritation. Although these prescribed and generic types of eye drops can reduce or eliminate the symptoms temporarily, they typically do not treat the cause, whether it is dryness, environmental irritation or some other problem. At this time, clinical trials of androgen suspension eyedrops are underway, as are trials of autologous serum eyedrops for which the patient periodically donates blood from which drops are synthesized. Autologous serum drops may have the advantages of elimination of allergic response and the provision of epitheliotrophic factors that occur naturally in tear film but which are necessarily absent from synthesized artificial tears. Unfortunately, Restasis, androgen-based, autologous serum-based and similar eye drops may have a low success rate, and can cost thousands of dollars per year.

Accordingly, there is a desire to provide an affordable and effective technique to help reduce the effects of Dry Eyes.

### SUMMARY OF THE INVENTION

Systems and methods for eyeglasses to help reduce symptoms of Dry Eyes are contemplated and described. In one embodiment, a shield is provided that can be coupled to an eyeglass frame. The shield includes a sheet of material that can extend between the eyeglass frame and a user's face during use. The sheet of material includes an insertion edge that couples to a shield mount channel of the eyeglass frame and a contact edge can be in contact or in near contact with a user's face during use. The shield can inhibit the evaporation of moisture from a user's eye region during use by creating a ‘moisture chamber’ in the region of the ocular surface which (substantially) does not exchange air with the ambient environment.

In another embodiment, an eyewear shield system is provided that includes an eyeglass frame. The eyeglass frame includes a rim that can secure an eyeglass lens and a shield mount including a channel that extends along at least a portion of an internal face of the rim that faces a user during use. The channel can receive an insertion edge of an eyewear shield that can inhibit the evaporation of moisture from a user's eye region during use.

In another embodiment, an eyewear shield system is provided including an eyeglass lens having a magnetic portion and a shield mount having a complementary magnetic portion configured to magnetically couple to the magnetic portion during use. The shield mount includes a channel to receive an insertion edge of an eyewear shield to inhibit the evaporation of moisture from a user's eye region during use.

In yet another embodiment, a method is provided that includes forming an eyewear shield that has an insertion edge that can be coupled to a channel of an eyeglass frame, forming a channel into an eyeglass frame that extends around at least a portion of a rim of the eyeglass frame, and coupling the insertion edge to the channel.

### BRIEF DESCRIPTION OF THE DRAWINGS

Advantages of the present invention will become apparent to those skilled in the art with the benefit of the following detailed description and upon reference to the accompanying drawings in which:

FIG. 1 is an illustration of eyeglasses including a shield in accordance with one or more embodiments of the present technique;

FIGS. 2A and 2B are illustrations of eyeglasses that can be used with shield in accordance with one or more embodiments of the present technique;

FIGS. 3A-3C are cross-sectional illustrations of a rim and a shield mount of eyeglasses in accordance with one or more embodiments of the present technique;

FIGS. 4A-4F are cross-sectional illustrations of a channel of the shield mount of the eyeglasses in accordance with one or more embodiments of the present technique;

FIGS. 5A and 5B are cross-sectional illustrations of the shield including an expansion feature in accordance with one or more embodiments of the present technique;

FIGS. 6A and 6B are cross-sectional illustrations of the shield including a contact edge formed in accordance with one or more embodiments of the present technique;

FIG. 7 is an illustration of the shield in accordance with one or more embodiments of the present technique;

FIG. 8A is a cross-sectional illustration of the shield including multiple shield portions in accordance with one or more embodiments of the present technique;

FIG. 8B is an illustration of the multiple shield portions in accordance with one or more embodiments of the present technique; and

FIG. 9 is a flowchart of a method of manufacturing eyeglasses in accordance with one or more embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

### Incorporation by Reference:

The following references are hereby incorporated by reference in their entirety as though fully and completely set forth herein:

U.S. Provisional Application Ser. No. 61/407,958, titled “Eyeglass System and Method”, filed Oct. 29, 2010.

In the following description, numerous specific details are set forth to provide a thorough understanding of the present invention. However, one having ordinary skill in the art should recognize that the invention may be practiced without various these specific details. In some instances, well-known structures and techniques have not been shown in detail to avoid obscuring the present invention.

As discussed in more detail below, certain embodiments include eyewear (e.g., eyeglasses) that are designed to help retain moisture around the eye region in an effort reduce the symptoms associated with Dry Eyes, such as itching, burning, and general eye irritation. In some embodiments, the eyeglasses include a shield that substantially encloses a region proximate to the eye to reduce the evaporation of moisture from the eye region. In certain embodiments, the shield includes a sheet of material that at least substantially spans a distance between a frame of the eyeglasses and the user's face, creating a barrier to inhibit moisture from escaping the eye region. In some embodiments, the sheet of material includes a flexible material that readily conforms to a profile of the user's face. In some embodiments, the shield includes a transparent sheet of material that is aesthetically pleasing. Such a transparent material may not be readily noticeable while the eyeglasses are being worn by a user. Certain embodiments include attachment of the shield to the eyeglass frame via a shield mount formed integrally with or attached to the frame. In some embodiments, the shield mount includes a channel that receives a complementary shaped edge of the shield. In some embodiments, the shield is provided as a substantially flat sheet that is or can be (curved or rolled and) attached to a rear portion of the frame to provide an elongate cylindrical-like enclosure defined by the lens, the surrounding shield, and the surface of a user's face. In certain embodiments, the shield is provided in a generic shape that is trimmed to fit by a user or a practitioner. In some embodiments, the shield is provided in a pre-cut shape based on a user's request and/or preliminary assessment of the user's facial profile. Such embodiments may help to provide a custom fit that increases effectiveness and comfort. In some embodiments, the shield includes multiple portions coupled in series to one another such that they extend between the frames and a user's face during use.

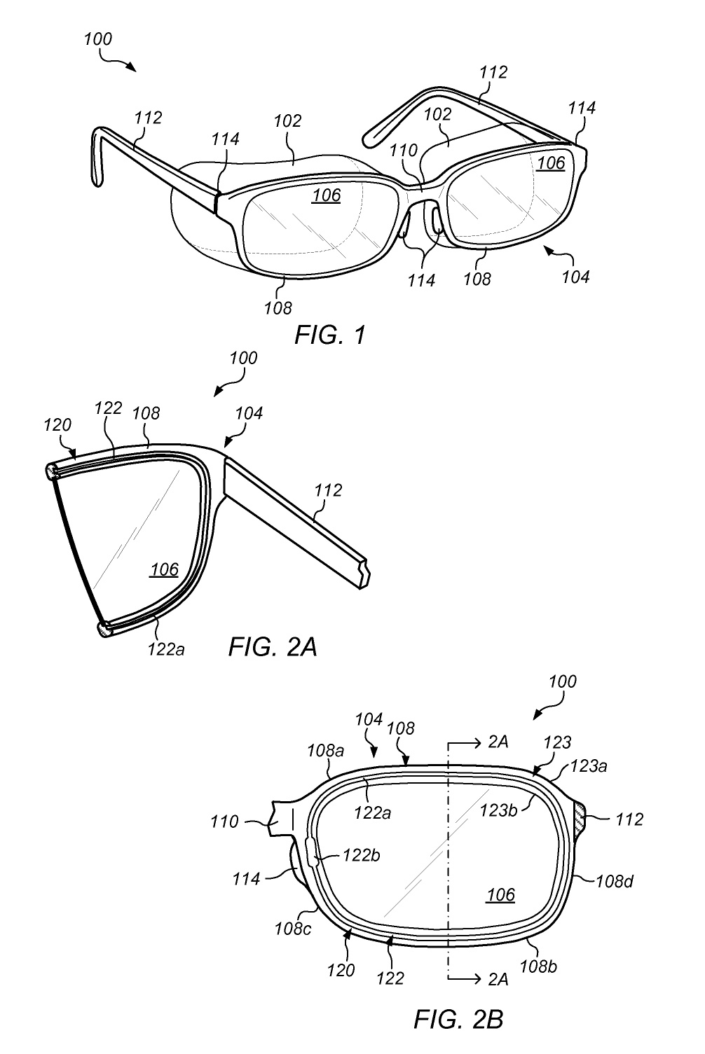

FIG. 1 illustrates eyeglasses 100 having shields 102, in accordance with one or more embodiments of the present technique. In the illustrated embodiment, shields 102 are coupled to a frame 104 of the eyeglasses 100. Frame 104 includes a generally ridged structure that rest on a users face, and that supports lenses 106 during use. In the illustrated embodiment, frame 104 includes a pair of rims 108, a bridge 110, a pair of arms 112, and a pair of nosepieces 114.

Rims 108 include portions of eyeglasses 100 that support lenses 106. In the illustrated embodiment, rims 108 include generally rectangular shaped members that entirely surround a perimeter of lenses 106. In other embodiments, rims 108 may include any of various shapes and sizes to support lenses 106. For example, rims 108 may include a substantially round or circular shape. In some embodiments, rims 108 may not entirely surround a perimeter of lenses 106. For example, rims 108 may surround only a side, lower, and/or upper portion of lenses 106. A rear/interior surface of rims 108 may be defined as a side or surface of rims 108 that faces a user during use (i.e., when worn by a user). Rims 108 may be formed of various materials, including metals, plastics, composites, or other materials. Rims 108 may be formed or attached to other portions of eyeglasses 100 via various techniques, including molding, extrusion, bending/forming, milling, soldering, welding, ultrasonic welding, press or interference fitting, interlocking parts, or the like.

Bridge 110 includes a portion of eyeglasses 100 that extends between the right and left sides of frame 104. Bridge 110 may extend between rims 108 and/or lenses 106. In the illustrated embodiment, bridge 110 includes a structure that extends between the pair of rims 108. Bridge 110 is typically located above or on the nose when eyeglasses 100 are worn on a person's face. Often, a user may handle eyeglasses 100 via bridge 110. Bridge 110 may be formed integral with rims 108, or may be formed as a separate piece that is subsequently joined to rims 108. Similar to rims 108, bridge 110 may be formed of various materials, including metals, plastics, composites, or other materials, and may be formed or attached to other portions of eyeglasses 100 via various techniques, including molding, extrusion, bending/forming, soldering, welding, ultrasonic welding, press or interference fit, interlocking parts, or the like.

Arms 112 include portions of eyeglasses 100 that extend from frame 104 to support eyeglasses 100 while being worn by a user. In the illustrated embodiment, arms 112 include elongated members that extend rearward from a back side of frames 104 such that they are positioned toward a user and are capable of being placed over a user's ears during use. As depicted, arms 112 may include curved portions that extend over the user's ears to help retain eyeglasses 100. In the illustrated embodiment, arms 112 also include hinges 114 that enable arms 112 to be folded into a closed or folded position. For example, arms 112 can be folded inward toward rims 108. Thus a user may fold both arms 114 inward toward a rear surface of rims 108 when eyeglasses 100 are not in use, such as during storage. In the illustrated embodiment, hinges 114 are located proximate to rims 108 such that eyeglasses 100 are substantially flat when arms 112 are closed (e.g., folded inward). In other embodiments, hinges 114 may be located a substantial distance (e.g., about one-half inch or more) from rims 108 such that when arms 112 are closed, a front end portion of arms 112 still extends rearward from rims 108, and a rear end portion of arms 112 fold inward and are generally parallel to rims 108 and lenses 106. Such an embodiment may enable arms 114 to be folded without contacting or substantially interfering with shield 102. In some embodiments, arms 112 may be substantially fixed such that they do not fold inward.

Nosepieces 114 include portions of eyeglasses 100 that rest on a user nose during use. Nosepieces 114 may include a soft or pliable material that is capable of at least partially conforming to a person's nose. In other embodiments, nosepieces 114 may include rigid structures. In the illustrated embodiment, nosepieces 114 include members coupled to a central portion of rims 108, below bridge 110. In other embodiments, nosepieces 114 may include members integrally formed with rims 108. For example, nosepieces 114 may include an exterior surface of an inner member of rims 108 that rests on the user's nose during use. Nosepieces 114 may be coupled to or integral with bridge 110 in other embodiments.

Shield 102 includes a portion of eyeglasses 100 that extends from frame 104. In the illustrated embodiment, shield 102 extends rearward from frame 104 such that it is located between portions of a user's face and frame 104 during use. For example, shield 102 includes an elongate sheet coupled around a perimeter of rims 108, and extending rearward from an internal face/surface of rims 108. During use, shield 102 may span some, substantially all, or the entirety of a distance between rims 108 and/or lenses 106 of eyeglasses 100 and a surface of the user's face. Such an arrangement may enclose the eye region, thereby creating a barrier to inhibit moisture from escaping the eye region. The “eye region” may refer to area located proximate to the eye, such as that surrounding the eye socket. For example, a perimeter of the eye region may be defined by the eyebrow, the nose, cheek, and a side region of the face between the eye socket and the ear, generally at or below the temple. For example, the eye region may include the portion of a user's face located directly behind eyeglasses when being worn. When eyeglasses 100 are being worn, the enclosed eye region may be defined by the region enclosed by shield 102, rims 108, frame 104, lenses 106, and/or the surface of a user's face. In an embodiment in which the shield spans the distance between rims 108 and/or lenses 106 of eyeglasses 100 and a surface of the user's face, edges or at least a portion of shield 102 that extend rearward may contact a user's face such that the shield extends from the user's face to frame 104, and forms a substantially enclosed eye region. For example, contact edges of shield 102 may contact or nearly contact the user's cheek, side of the eye near the temple, eyebrow, and/or the upper nose region.

In some embodiments, the enclosed eye region may or may not be entirely sealed. For example, the enclosed eye region may not be entirely sealed when at least a portion of the rear (e.g., contact) region of shield 102 does not contact and seal against the surface of a user's face. Since a user is likely to move, causing the rear edges (e.g., contact edges) to pull away from the surface of a user's face, it is expected that a complete seal, even if present at some point during use, may not occur at all times. In some embodiments, all or substantially all of the contact edges of shield 102 may contact or nearly contact the user's face around the eye to provide a substantially complete seal or barrier for the enclosed eye region. In any event, the enclosed eye region may provide a substantially sealed or enclosed region that helps to reduce the evaporation of tears or similar fluids from the eye and the eye region, whether or not the region is entirely sealed. By reducing the evaporation of fluids in the eye region, it is believed that symptoms of Dry Eyes can be reduced. Further, such a barrier may help to inhibit dust, pollen, mold, or other types of airborne debris from contacting and irritating the eye. Accordingly, eyeglasses 100 may be helpful for those suffering from Dry Eyes or similar symptoms, as well as helpful to persons exposed to dusty conditions, such as construction workers, carpenters, painters, and the like.

In some embodiments, a portion of the shield may be directly coupled to a portion of frames 104 or another portion of eyeglasses 100. For example, as depicted in FIG. 1, a front edge of shield 102 may be coupled to the rear edge or face of frames 104. In some embodiments, shield 102 may be coupled to frames 104 via interference fit, ultrasonic welding, an adhesive, interlocking parts, brackets, or the like. In some embodiments, frames 104 may include a mount or similar feature that facilitates attachment of shield 104 to frames 104 or another portion of eyeglasses 100.

FIGS. 2A and 2B illustrate eyeglasses 100 having a mount for shield 102, in accordance with one or more embodiments of the present technique. FIG. 2A is a rear/interior view of a right side of eyeglass frames 104 and respective right side lens 106. It may be said that FIG. 2A is a view of frames 104 in the direction a user would normally look through eyeglasses 100. FIG. 2B is a rear/interior perspective view of eyeglasses 100 that includes a cross-section taken across line 2B-2B of FIG. 2A. It will be appreciated that, although not depicted in FIGS. 2A and 2B to improve clarity, the left side of eyeglasses 100 may include a mirror image of the right side of eyeglasses 100, as depicted in FIG. 1.

Eyeglasses 100 include frame 104, lens 106, bridge 110, nosepiece 114, and lens 106. Rim 108 includes a top member 108a, a bottom member 108b, an inner member 108c and an outer member 108d. During use, bottom member 108b may be disposed proximate to a user's cheek, inner member 108c may be disposed proximate to a user's nose, and outer member 108d may be disposed proximate to an outer corner of the user's eye or eye socket in the direction of the ear. In the illustrated embodiment frame 120 includes a shield mount 120. Shield mount 120 may facilitate coupling of shield 102 to frame 104. For example, shield 102 may be installed into or otherwise coupled to shield mount 120 such that shield 102 extends between frames 104 and a users face during use. In some embodiments, shield 120 includes an elongate sheet of material that, when mounted to shield mount 120, extends in a direction substantially perpendicular to the plane of the lens 106 and/or an interior surface of rim 108. (See FIG. 1). Shield mount 120 may enable shield 102 to be removed, installed, or replaced by a user. For example, a user may slide or snap an edge of a shield 102 through or into shield mount 120.

In some embodiments, shield mount 120 includes a channel 122 that extends along at least a portion of rim 108. In the illustrated embodiment, channel 122 includes a path that extends around the entirety of rim 108 to form a loop. In other embodiments, channel 122 may extend along only a portion of rim 108. For example, channel 122 may include a path along upper member 108a, outer member 108d, and lower member 108b, forming a C-shape that terminates on each end. Other partial circum-extensions are also contemplated.

Channel 122 may include a slot formed along a rear/inside facing surface of rim 108. In the illustrated embodiment, the slot includes an indentation that extends from a rear surface of rim 108 into an internal portion of rim 108. In some embodiments, channel 122 may include a slot that is shaped complementary to an edge of shield 102 that is to be disposed in channel 122. Such an arrangement may facilitate insertion and/or retention of shield 102 in channel 122.

As depicted in FIG. 2A, channel 122 includes a path located between an exterior edge and an interior edge of rim 108. In some embodiments, channel 122 may include or form a contiguous path that extends about the entire periphery of rim 108, as depicted. For example, in the illustrated embodiment, channel 122 includes a substantially rectangular shape path that is substantially the same as the shape as rim 108. Note, however, that in other embodiments, channel 122 may include or form a path having any of a variety of shapes. In some embodiments, channel 122 may be shaped to match the shape of rim 108 or another portion of frame 104. For example, where rim 108 includes a circular shape, channel 122 may include a substantially circular shaped path. In the illustrated embodiment, channel 122 extends all the way around rim 108. In other embodiments, channel 122 may extend around only a portion of rims 108. For example, channel 122 may include a single elongate slot on one of the top, bottom, inner or outer members of rim 108, or may include a C-shape channel 122 that extends across several of the top, bottom, inner or outer members, of rim 108.

In the illustrated embodiment, channel 122 is located on an interior surface of rim 108, between an outer edge and an inner edge of rim 108. For example, channel 122 is centered between outer edges 123a and inner edges 123b of inner surfaces 123 of top member 108a, bottom member 108b, inner member 108c, and outer member 108d. In other embodiments, channel 122 may be formed closer to one edge than another. For example, channel 122 may be formed at or near outer edge 123a or inner edge 123b of rim 108. In some embodiments, a portion of channel 122 may be formed at or near an outer edge, while another portion may be formed at or near an inner edge of rim 108. Further, in some embodiments, channel 122 may include variations, such as curves, and a varying path that does not substantially follow the shape (e.g., the outer or inner edge) of rim 108. For example, a portion of channel 122 along inner surface 123 of top member 108a may be curved toward and run proximate to outer edge 123a near a center portion of top member 108a, and may curve toward and run proximate to inner edge 123a at or near the right and left ends of the top member 108a (e.g., at or near inner member 108c and outer member 108d). Such a feature may help to define a shape of shield 102 when it is installed in channel 122 of shield mount 120. For example, the described curvature may cause shield 102 to curve such that it matches the curvature of the user's eyebrow during use. Moreover, in some embodiments, channel 122 may vary in curvature and position with respect to rim 108, e.g., sinusoidally, to help secure shield 102 in channel 122, e.g., by causing transverse pressure of the shield against sidewalls of the channel.

In some embodiments, channel 122 may include a slot having a flanged interior portion and necked portion at or near a surface of rim 108. In other words, channel 122 may include an interior slot having a wide cross-section and an external slot having a narrow cross-section that extends from the surface of rim 108 to the interior slot. In some embodiments, an insertion edge of shield 102 may be inserted (e.g., snapped or slid) into the interior portion and be retained by the necked portion. For example, the insertion edge may include a flanged lip that seats in the internal portion and is retained by the necked portion. In some embodiments, the necked portion may have a cross-section smaller than the cross-section of shield 102, such that is compresses shield 102 within the necked portion and retains the shield whether or not the insertion edge includes a lip or similar feature.

In the illustrated embodiment, channel 122 includes a first portion 122a and a second portion 122b. In some embodiments, first portion 122a may be sized and shaped to retain at least an edge of shield 102, and second portion 122b may include region that facilitates insertion of at least a portion of an edge of shield 102. For example, in the illustrated embodiment, first portion 122a includes a slot having a first width, and second portion 122b includes a slotted region 122b having a second width that is greater that the first width. The first and second widths may be defined by a width of channel 122 at a surface, such as the interior surface, of rim 108. First potion 122a of channel 122 may include a slot having a flanged interior portion and necked portion near the surface of rim 108. The flanged interior portion may include a width sufficient to accept an insertion edge of shield 102, and the necked portion may include a smaller width sufficient to retain the insertion edge of shield. Second portion 122b may include a width sufficient to pass a flanged/wide insertion edge of shield 120 there through. For example, second portion 122b may include an opening, such as a slot or depression, that does not include any necking or similar feature that may be used to retain shield 102. In some embodiments, the insertion edge of shield 102, including any flanged edge, can be inserted into the opening defined by second portion 122b and subsequently slid sideways into the adjacent flanged portion of first portion 122a. Second portion 122b may be helpful with various types of shields 120. For example, even where shield 120 includes a relatively flat edge, second portion 122b may provide an opening that acts as a funnel to help a user thread the insertion edge of shield 120 into first portion 122a.

In some embodiments, installation of shield 102 includes inserting a leading/first end of shield 102 into second portion 122b, and advancing the leading first/end of shield 102 into first portion 122a. The leading first/end of shield 102 may be advanced along the first portion 122a until the leading/first edge has been fully inserted (e.g., traveling entirely around first portion 122a and terminating into second portion 122b). With shield 102 fully inserted, a second/trailing end of shield 102 may be located in or have traveled through second portion 122b. In some embodiments, shield 102 may have a length, such that, when shield 102 is fully inserted, the first/leading edge and the second/trailing edge of shield 102 are near one another, substantially align with one another, or overlap with one another at or near second portion 122b. In some embodiments, the two ends can be coupled to one another to further facilitate enclosure of the eye-region during use. In some embodiments, shield 102 may be advanced such that first/leading and second/trailing edges are located along first portion 122a. In an embodiment in which channel 122 does not include or form a continuous loop (e.g., includes or forms a C-shape), a second portion 122 may be located at one or both ends of channel 122 and shield 102 may be inserted into first portion 122a via second portion 122b.

In the illustrated embodiment, second portion 122b is located proximate to nosepiece 114 and the portion of the eyeglasses 100 that rests on a user's nose. During use, location of second portion 122b and the respective ends of shield 102 that terminate at or near second portion 122b may be hidden from view by nosepiece 114, bridge 110, or a similar portion of eyeglasses 100 proximate to the user's nose. Such an arrangement may also prevent contact of the ends of shield 102 that terminate at or near second portion 122b with the user's nose. In other embodiments, second portion 122b may be provided at another location of eyeglasses 100. For example, second portion 122b may be formed at or near the intersection of arm 112 with rim 108. Further, more than one second portion 122b may be provided. Such an embodiment may simplify installation of shield 102 by providing more than one location for insertion of shield 102.

In the illustrated embodiment of FIGS. 2A and 2B, shield mount 120 includes channel 122 integrally formed with rim 108. For example, channel 122 includes a slot formed in interior surface 123 of rim 108. In some embodiments, channel 122 includes a slot that is cut, molded, or otherwise formed into interior surface 123 of rim 108. In some embodiments, channel 122 is cut directly into top member 108a, bottom member 108b, inner member 108c, and outer member 108d. For example, in some embodiments, after rim 108 has been formed, channel 122 may be milled into rim 108. Such a technique may be suitable for eyeglasses that are manufactured for use with a shield, as well as for use in retrofitting existing frames 104 for use with shield 102. Channel 122 may be formed into a user's existing frames to enable shield 102 to be coupled thereto. In some embodiments, rim 108 may include a molded (e.g., injection molded) plastic frame that includes channel 122 formed therein.

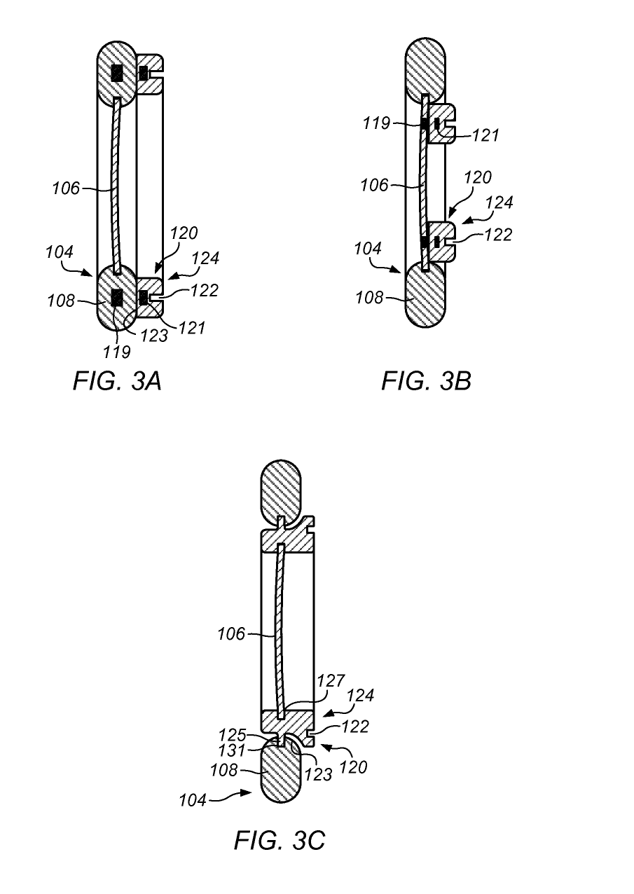

In some embodiments, shield mount 120 may not be integrally formed with rim 108. FIG. 3A is a side view of a cross-section of frame 104 that illustrates shield mount 120 and rim 108, in accordance with one or more embodiments of the present technique. In the illustrated embodiment, shield mount 120 includes a body 124 that is directly coupled to an interior surface 123 of rim 108. For example, body 124 may be coupled to rim 108 via use of an adhesive, a mechanical fastener (e.g., a screw or clip), soldering, ultrasonic welding, magnetic coupling, press or interference fit, interlocking parts, or the like. In some embodiments, rim 108 may be manufactured to include a magnetic portion 119. For example, magnets or a magnetic material may be attached to and/or be integrally formed (e.g., embedded) within rim 108. In some embodiments, shield mount 120 may include a complementary magnetic portion 121 that is magnetically attracted to magnetic portion 119 of rim 108. Shield mount 120 may be disposed at or near a surface of rim 108 and/or magnetic portion 119 such that attraction between magnetic portion 119 and complementary magnetic portion 121 magnetically couples shield mount 120 to rim 108. Such a technique may be suitable for eyeglasses that are manufactured for use with a shield, as well as for use in retrofitting existing frames 104 for use with shield 102. For example, a user may have body 124 coupled to their existing frames such that shield 102 can be coupled to the existing frames.

In some embodiments, body 124 extends along a similar path to that of channel 122 described above with respect to FIGS. 2A and 2B. For example, body 124 may be coupled to interior surfaces 123 of upper member 108a, lower member 108b, inner member 108c, and/or outer member 108d. As depicted, body 124 may include channel 122 formed therein. Channel 122 may be similar to that described above with respect to FIGS. 2A and 2B. For example, channel 122 may include first and second portions that extend along an interior surface 124a of body 124.

In some embodiments, shield 102 may be formed integrally with shield mount 120. For example, in some embodiments, shield 102 and shield mount 120 may include a contiguous piece of eyewear 100 that is coupled to frames 104. Accordingly, in some embodiments, shield 102 may be coupled directly to frames 104, such as in an embodiment in which shield 102 is formed integrally with the shield mount 120.

In some embodiments, shield mount 120 may be coupled to lens 106. FIG. 3B is a side view of a cross-section of frame 104 that illustrates shield mount 120 and rim 108, in accordance with one or more embodiments of the present technique. In the illustrated embodiment, shield mount 120 includes a body 124 that is directly coupled to an interior surface of lens 106. For example, body 124 may be coupled to lens 106 via use of an adhesive, a mechanical fastener (e.g., a screw or clip), soldering, ultrasonic welding, magnetic coupling, press or interference fit, interlocking parts, or the like. In some embodiments, lens 106 may be manufactured to include a magnetic portion 119. For example, magnets or a magnetic material may be attached to and/or formed integral with (e.g., embedded within) lens 106. In some embodiments, shield mount 120 may include complementary magnetic portion 121 that is magnetically attracted to the magnetic portion 119 of lens 106. Shield mount 120 may be disposed at or near a surface of lens 106 and/or magnetic portion 119 such that attraction between magnetic portion 119 and complementary magnetic portion 121 magnetically couples shield mount 120 to lens 106. Such a technique may be suitable for eyeglasses that are manufactured for use with a shield, as well as for use in retrofitting existing frames 104 and lenses 106 for use with shield 102. For example, a person may have body 124 coupled to their existing frames such that shield 102 can be coupled to the existing frames.

In some embodiments, shield 102 may be formed integrally with shield mount 120 including complementary magnetic portion 121. For example, in some embodiments, shield 102 and shield mount 120, including a complementary magnetic portion 121, may include a contiguous piece of eyewear 100 that is coupled to frames 104. Accordingly, in some embodiments, shield 102 may be magnetically coupled directly to frames 104, such as in an embodiment in which shield 102 is formed integrally with shield mount 120.

In some embodiments, shield mount 120 may be coupled to an interior edge of frames 104. The interior edge may include a portion of frames 104 where a lens is traditionally disposed. In such an embodiment, shield mount 120 may be disposed between an external edge of lens 106 and an interior edge of frames 104, and include a location for mounting shield 102. FIG. 3C illustrates shield mount 120 installed within an interior edge 123 of rims 108. In the illustrated embodiment, shield mount 120 includes a protrusion 125 that enables shield mount 120 to be slid over interior edge 123 of frame 104 and snapped into lens channel 131 of rim 108. In such an embodiment, shield mount 120 may be coupled between frames 104 and lens 106. In the illustrated embodiment, shield mount 120 includes a notch 127 along its interior that captures the edge of lens 106. Shield mount 120 also includes channel 122 that extends about or around a portion or all of a perimeter of body 124. In some embodiments, shield mount 120 may extend about or around a portion or all of interior edge 123 of frames 104. In some embodiments, shield mount 120 is snapped into place. In some embodiments, shield mount 120 may be formed of a highly transparent material, such as a clear plastic, that helps to hide shield mount 120 from view, i.e., to reduce visibility of shield mount 120. A width of shield mount 120 may be minimized to reduce its impact on the fit of eyeglasses 100. For example a thickness of the shield mount 120 may be reduced such that lens 106 may be cut only slightly smaller in size than it would be to fit within channel 131, to fit within notch 127. In some embodiments, a width of shield mount 120 may be about the same size or less than the width of rim 108 such that a minimal amount of shield mount 120 extends from the front or back of rims 108. Such a technique may be suitable for eyeglasses that are manufactured for use with a shield, as well as for use in retrofitting existing frames 104 and lenses 106 for use with shield 102. For example, a person may have body 124 coupled to their existing frames such that shield 102 can be coupled to the existing frames.

In some embodiments, shield 102 may be formed integrally with shield mount 120. For example, in some embodiments, shield 102 and shield mount 120 may include a contiguous piece of eyewear 100 that is capable of being coupled between lens 106 and rims 108 or similar portions of frames 104. In other words, a channel typically configured to accept a lens may be used as a shield mount channel, and the shield mount may include an additional channel for securing the lens. Accordingly, in some embodiments, shield 102 may be directly coupled to interior edge 123 of frames 104, such as in an embodiment in which shield 102 is formed integrally with shield mount 120.

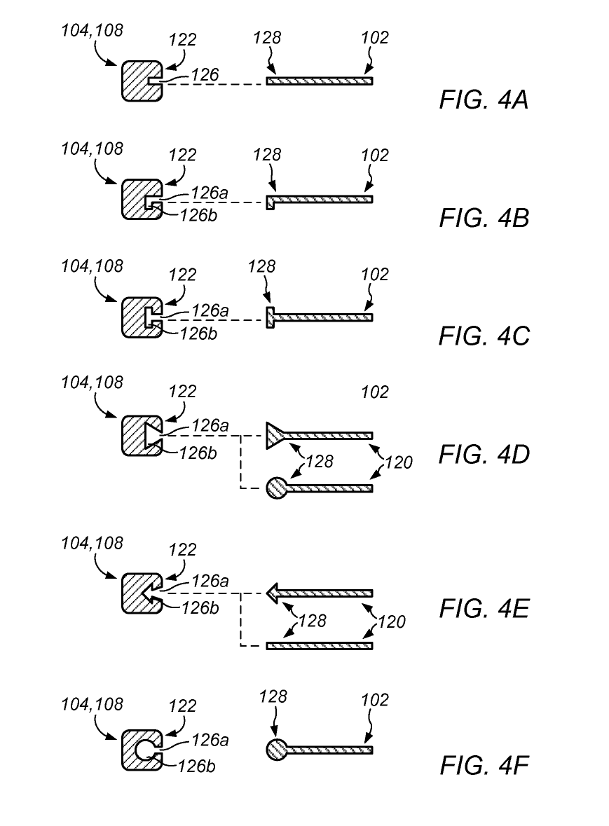

As discussed above, channel 122 may include a slot or similar feature that is able to retain shield 120. Channel 122, for instance, may include a slot that is capable of accepting a complementary feature of shield 102, such as a lip or flange that can be slid or snapped into the slot. FIGS. 4A-4F illustrate cross-sectional views of various exemplary configurations of channel 122 in accordance with one or more embodiments of the present technique. FIG. 4A illustrates an embodiment of channel 122 that includes a straight slot 126. In the illustrated embodiment, straight slot 126 includes a slot having a substantially constant width from the start of slot 126 at or near interior face 123 of rim 108 to the termination of slot 126 at an interior portion of rim 108.

As depicted in FIG. 4A, shield 102 may include a complementary insertion edge 128 that can be inserted into slot 126 of channel 122. For example, in the illustrated embodiment, insertion edge 128 includes a straight portion of shield 102 having a substantially constant thickness. Insertion edge 128 does not include a lip, protrusion, or similar feature. In some embodiments, a thickness of insertion edge 128 may be about the same or less than the width of slot 126. This may facilitate insertion of insertion edge 128 into slot 126 with little to no effort or force. In another embodiment, a thickness of insertion edge 128 may be about the same or greater than the width of slot 126. This may facilitate an interference fit between insertion edge 128 and slot 126 that may retain shield 102 within slot 126 and rim 108.

FIG. 4B illustrates an embodiment of channel 122 that includes an L-shaped slot 126. As depicted, in some embodiments, channel 122 includes two slot portions 126a and 126b. Slot portion 126a includes a substantially straight slot extending from interior face 123 of rim 108 to an interior portion of rim 108. Slot 126a extends in a direction substantially perpendicular to interior face 123 and the plane of lens 106 (See FIGS. 1-2B). Slot portion 126b includes a substantially straight slot extending from an end of slot 126a at an interior of rim 108. Slot 126b extends in a substantially perpendicular orientation relative to slot 126a. In the illustrated embodiment, both portions of slot 126 include a substantially constant width from a beginning of slot 126 at interior face 123 of rim 108 to the end of slot 126 at an interior of rim 108.

As depicted in FIG. 4B, shield 102 may include a complementary insertion edge 128 that can be inserted into slot 126 of channel 122. For example, in the illustrated embodiment, insertion edge 128 includes an L-shaped lip. In the illustrated embodiment, the members forming the L-shaped lip have substantially constant thicknesses that are the same or about the same as the thickness as the elongate portion of shield 102 that extends between the frames and a user's face. In some embodiments, the members forming the L-shaped lip have thicknesses that are about the same or less than the width of complementary portions of slot 126. This may facilitate insertion of insertion edge 128 into slot 126 with little to no effort or force. In another embodiment, the members forming the L-shaped lip have thicknesses that are about the same or greater than the widths of complementary portions of slot 126. This may facilitate an interference fit between portions of insertion edge 128 and slot 126 to retain shield 102 within slot 126 and rim 108.

FIG. 4C illustrates an embodiment of channel 122 that includes a T-shaped slot 126. As depicted, in some embodiments, channel 122 includes two slot portions 126a and 126b. Slot portion 126a includes a substantially straight slot extending from interior face 123 of rim 108 to an interior portion of rim 108. Slot portion 126b includes a substantially straight slot extending in either direction from the end of slot 126a at an interior of rim 108. Slot 126b extends in a substantially perpendicular orientation relative to slot 126a. In the illustrated embodiment, both portions of slot 126 include a substantially constant width from a beginning of slot 126 at interior face 123 of rim 108 to the end of slot 126 at an interior of rim 108.

As depicted in FIG. 4C, shield 102 may include a complementary insertion edge 128 that can be inserted into slot 126 of channel 122. For example, in the illustrated embodiment, insertion edge 128 includes a T-shaped lip. In the illustrated embodiment, the members forming the T-shaped lip have substantially constant thicknesses that are the same or about the same as the thickness of the elongate portion of shield 102 that extends between the frames and a user's face. In some embodiments, the members forming the T-shaped lip have thicknesses that are about the same or less than the width of complementary portions of slot 126. This may facilitate insertion of insertion edge 128 into slot 126 with little to no effort or force. In another embodiment, the members forming the T-shaped lip have thicknesses that are about the same or greater than the widths of complementary portions of slot 126. This may facilitate an interference fit between portions of insertion edge 128 and slot 126 to retain shield 102 within slot 126 and rim 108.

FIG. 4D illustrates an embodiment of channel 122 that includes a triangular-shaped slot 126. As depicted, in some embodiments, channel 122 includes a tapered slot having a width that increases as the slot extends away from interior surface 123 of rim 108. In other words, a first portion 126a of slot 126 proximate to the surface of rim 108 has a first width, and a second portion 126b of slot 126 proximate to an interior of rim 108 has a second width larger than the first width, such that the first portion 126a forms a necked region. The second portion 126a may thus help to retain a complementary lip or flanged edge of shield 102.

As depicted in FIG. 4D, shield 102 may include a complementary insertion edge 128 that can be inserted into slot 126 of channel 122. For example, in one of the illustrated embodiments, insertion edge 128 includes a substantially triangular-shaped lip. In another of the illustrated embodiments, insertion edge 128 includes a substantially circular-shaped lip of shield 102. The leading edge of the triangular shaped or circular shaped insertion edge 128 may include a thickness that is greater than width of the first portion 126a of slot 126. In such an embodiment, first portion 126a may retain insertion end 128 within slot 126 of rim 108.

FIG. 4E illustrates an embodiment of channel 122 that includes an arrow-shaped slot 126. As depicted, in some embodiments, channel 122 includes a tapered slot having two slot portions that each decrease in width as the slot extends away from interior surface 123 of rim 108. In the illustrated embodiment, a first portion 126a of slot 126 proximate to interior surface 123 has a profile decreasing in width from a first width proximate to interior surface 123 to a second width proximate to an interior region of rim 108, the second width being smaller than the first. An opening extends from first portion 126a into a second portion 126b of slot 126 located at an interior region of rim 108. Second portion 126a has a profile decreasing from a third width proximate to the opening to a tapered end having a fourth width that is smaller than the third. In the illustrated embodiment, the funnel-like shape of first portion 126a may facilitate capture of an insertion edge of shield 102. The smaller second width may define a necked portion that facilitates retention of an insertion edge of shield 102. For example, the necked portion may retain a complementary lip or flanged edge of shield 102 having a thickness greater than the second width.

As depicted in FIG. 4E, shield 102 may include a complementary insertion edge 128 that can be inserted into slot 126 of channel 122. For example, in one of the illustrated embodiments, insertion edge 128 includes a substantially straight and flat edge of shield 102 having a substantially constant thickness. In another of the illustrated embodiments, insertion edge 128 includes a triangular-shaped edge of shield 102. In some embodiments, the leading edge of the insertion edge 128 (e.g., the straight-flat edge or the triangular shaped edge) may include a thickness that is greater than the second width. In such an embodiment, the necked portion formed between first portion 126a and second portion 126b may retain insertion edge 128 of shield 102 within slot 126 of rim 108.

FIG. 4F illustrates an embodiment of channel 122 that includes a circular-shaped slot 126. As depicted, in some embodiments, channel 122 includes a first portion 126a including a straight slot that extends from a surface of rim 108 and terminates into a second portion 126b that includes circular opening at an interior region of rim 108. The second portion 126a may retain a complementary lip or flanged insertion edge of shield 102.

As depicted in FIG. 4F, one embodiment of shield 102 may include a complementary insertion edge 128 that can be inserted into slot 126 of channel 122. For example, insertion edge 128 includes a substantially circular-shaped lip. In the illustrated embodiment, the circular portion of insertion edge includes a diameter/thickness that is greater than a width of first portion 126a of slot 126. When insertion edge 128 is inserted into slot 126, first portion 126a may retain shield 102 within slot 126 of rim 108.

It should be noted that in other embodiments, differently shaped lips and slots may be used. For example, in an alternative version of the embodiment shown in FIG. 4B, the L shape may turn or bend in the opposite direction. In other words, rather than turning inward (towards the interior or center of the lens), the L shape may turn outward (away from the interior or center of the lens).

As depicted and discussed above, shield 102 may extend from frames 104 of eyeglasses 100 to at or near a user's face to substantially enclose an eye region. Enclosure of the eye region may help to retain moisture and inhibit evaporation of moisture from the eye. Accordingly, in some embodiments, it may be desirable for shield 102 to contact and seal against the user's face. For example, a portion of shield 102 opposite an insertion edge coupled to frames 104 may include a contact edge that contacts or nearly contacts a user's face during use. In such embodiments, it may also be desirable to increase comfort to the user when contact edge contacts the user's face.

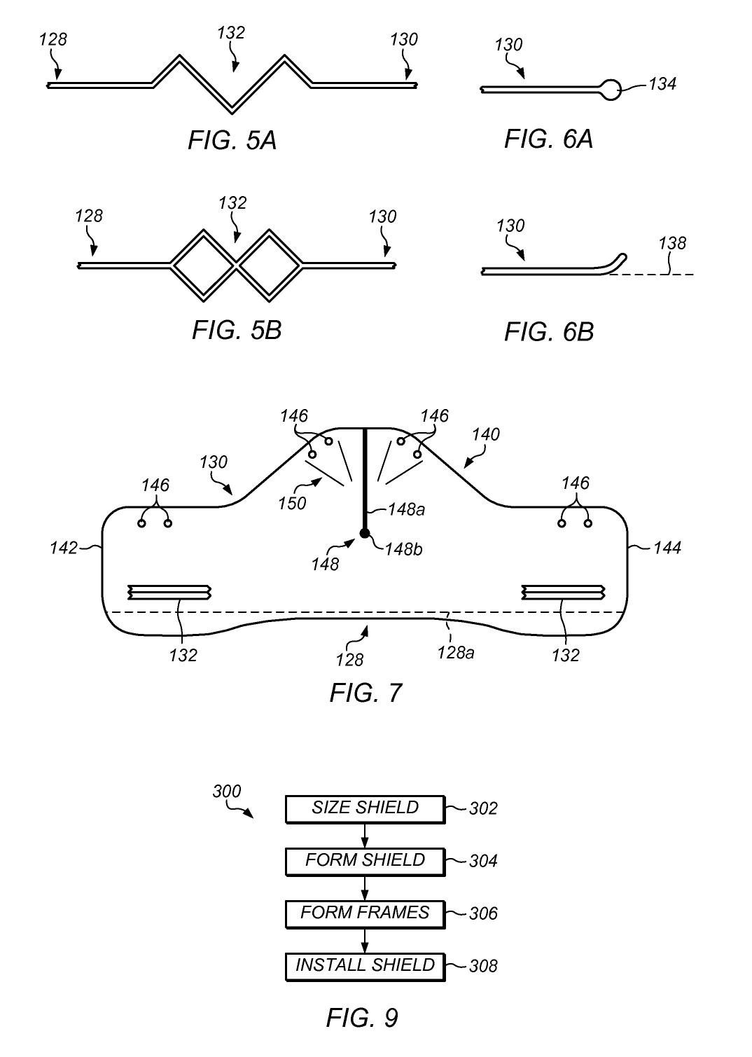

FIGS. 5A and 5B illustrate cross-sectional views of shield 102 in accordance with one or more embodiments of the present technique. In the illustrated embodiments, shield 102 includes features that facilitate maintaining a seal to a user's face while also relieving pressure against the user's face to increase comfort. For example, the illustrated embodiments include folds and bellows that allow shield 102 to extend and contract to enclose the eye region while regulating the amount of pressure exerted by a the portion of the shield 102 that contacts a user's face (e.g., the contact edge).

FIG. 5A illustrates a cross section of shield 102 that includes an insertion edge 128, a contact edge 130, and an extension feature 132 disposed there between. Insertion edge 128 may include an edge of shield 102 that is inserted into channel 122 of rim 108 during use as described above with respect to FIGS. 1-4F. Contact edge 130 may include a portion (e.g., an edge) of shield 102 that comes into contact or near contact with a user's face during use. In the illustrated embodiment, extension feature 132 includes multiple folds formed integral with shield 102. The folds include an accordion-like arrangement. In some embodiments, the folds may extend substantially parallel to members of frame 104 when shield 102 is installed in frame 104. During use, the folds may facilitate the extraction and expansion of shield 102 to relieve pressure on a user's face. For example, when eyeglasses 100 are moved away from the user's face, folds of extension feature 132 may flatten out such that the length (e.g., the distance from insertion edge 128 to contact edge 130) of shield 102 increases to maintain contact with the users face. Similarly, when eyeglasses 100 are moved toward the user's face, folds of extension feature 132 may contract toward one another such that the length of shield 102 decreases to reduce pressure on the user's face while still maintaining contact with the users face. In some embodiments, extension feature 132 may be formed by extruding or molding the folds into the sheet of material used to form shield 102. In other embodiments, any number of folds or similar features may be used to form extension feature 132.

FIG. 5B illustrates another embodiment of extension feature 132 that includes multiple bellows formed integral with shield 102. The bellows include folds that encompass a void interior region. In some embodiments, the void interior region may include a sealed region filled with a gas, such as atmospheric air, or a non-sealed region that enables atmospheric air to enter and escape from the void interior region as the bellows are expanded and contracted. In the illustrated embodiment, the bellows include an accordion-like arrangement. In some embodiments, the bellows may extend substantially parallel to the members of frame 104 when shield is installed in frame 104. During use, the bellows may facilitate the extraction and expansion of shield 102 to relieve pressure on a user's face. For example, when eyeglasses 100 are moved away from the user's face, bellows of extension feature 132 may flatten out such that the length of shield 102 increases to maintain contact with the users face. Similarly, when eyeglasses 100 are moved toward the user's face, bellows of extension feature 132 may contract toward one another such that the length of shield 102 decreases to reduce pressure on the user's face while still maintaining contact with the users face. In some embodiments, extension feature 132 may be formed by extruding or molding the bellows into the sheet of material used to form shield 102. In other embodiments, any number of bellows or similar features may be used to form extension feature 132.

FIGS. 6A and 6B illustrate cross-sectional views of shield 102 in accordance with one or more embodiments of the present technique. In the illustrated embodiments, shield 102 includes features that facilitate maintaining a seal to a user's face while also providing increased comfort at points of contact between shield 102 and the user's face. For example, the illustrated embodiments include rounded and curved lips/edges that may be comfortable to a user during contact with the user's face. FIG. 6A illustrates a cross section of contact edge 130 of shield 102 in accordance with one or more embodiments of the present technique. In the illustrated embodiment, contact edge 130 includes a circular protrusion 134. Circular protrusion may extend a portion, substantially all, or all of contact edge 130 of shield 102. In such an embodiment, circular protrusion 134 may help to distribute the contact forces generally associated with contact edge 130 of shield 102 as it is pressed against a user's face. FIG. 6B illustrates a cross section of contact edge 130 of shield 102 in accordance with one or more embodiments of the present technique. In the illustrated embodiment, contact edge 130 includes a curved edge 136. Curved edge 136 includes a portion of shield 102 having a substantially constant thickness and that is curved away from a plane 138 that that is substantially perpendicular to a user's face during use. In such an embodiment, curved edge 136 may help to distribute the contact forces generally associated with contact edge 130 of shield 102 as it is pressed against a user's face. Moreover, in some embodiments, the curved edge 136 may be configured or constructed such that increased pressure against the user's face causes increased curling of the edge, and decreased pressure against the user's face causes decreased curling of the edge, thereby extending or retracting the shield while substantially maintaining a seal with the user's face. Note that in various embodiments, the direction of curl/curvature of the edge may be inward or outward with respect to the user's eye region. Additionally, in some embodiments, the thickness of the sheet may be tapered or feathered at or near the contact edge to facilitate the curling/curvature, thereby providing improved sealing functionality and comfort to the user. In other words, the sheet may be thinner at or near the contact edge to reduce stiffness (increase flexibility), and thus provide a softer more comfortable fit against the user's face.

In some embodiments, shield 102 may include a sheet of material that is coupled to frames 104 as descried herein. In some embodiments, shield 102 may be formed from a transparent, thin, and flexible sheet of material, such as Moist Eye Panels manufactured by Eagle Vision having headquarters in Memphis, Tenn. In some embodiments, a sheet of material used to form shield 102 is molded, cut, extruded, or the like to include one or more desirable features. For example, in some embodiments, a sheet used to form shield 102 may be formed to include one of the above described styles or configurations of insertion edges, expansion features, contact edges, or the like. Further, other embodiments may include forming the sheet to include vent holes, creases, slots, curvature(s), flaps, or the like. For example, slots, creases, curvature(s), and flaps may be cut or formed into a sheet used to form shield 102 to ensure that, when installed, shield 102 includes a proper fit to a user's face, or to allow the eyeglasses to be folded closed without inducing undesirable folds or bends into the material of shield 102.

FIG. 7 illustrates a shield 102 formed in accordance with one or more embodiments of the present technique. The illustrated embodiment includes a depiction of shield 102 lying in a substantially flat/planner manner. Shield 102 may be provided in a substantially flat configuration prior to installation into shield mount 120 of eyeglasses 100. For example, shield 102 may be provided as a flat sheet of material having an insertion edge that is slid or snapped into a channel in rims of eyeglasses, at which point shield 102 may take on a substantially cylindrical or similar shape, such as that depicted in FIG. 1.

In the illustrated embodiment, shield 102 includes a leading/first end 142, a trailing/second end 144, and an insertion edge 128, and contact edge 130. As described above with respect to FIG. 2B, leading/first end of shield 102 may be inserted (e.g., slid or snapped) into channel 122 and advanced until the entirety of insertion edge 128 has been mated with channel 122. When shield 102 has been fully inserted, leading/first end 142 and trailing/second end 144 may be proximate to one another, with shield 102 forming a cylindrical-like shape, as depicted in FIG. 1. Insertion edge 128 includes an edge of shield 120 that may be inserted or otherwise coupled to or mated with frame 104. Insertion edge may include various features, such as those described above with respect to FIGS. 4A-F. Contact edge includes an edge of shield 120 that may be in contact or near contact with a user's face during use. Contact edge 130 may include various features, such as those described above with respect to FIGS. 6A and 6B, for example.

Shield 102 may be formed or cut to a shape that is conducive to enclosing the eye region. For example, in the illustrated embodiment, sealing edge 130 includes a protrusion 140 near a center of shield 102 between first end 142 and second end 144. Protrusion 140 may help to enclose a portion of the eye region proximate the side of a user's face (e.g., near arms 112). For example, in some embodiments, when shield 102 is installed into frames 104 of eyeglasses 100, such as those depicted in FIGS. 1-2B, a portion of the shield proximate to first end 142 may be disposed proximate to bottom member 108b (see FIG. 2B) of rim 108 and may extend toward a user's cheek area, and a portion of shield 102 proximate to second end 144 may be disposed proximate to top member 108c and may extend toward a user's eyebrow area. A central portion may be disposed proximate to side member 108d and may extend toward a user's ear. The addition of protrusion 140 may enable shield 102 to extend into contact or near contact with sides of the user's face, while the ends of shield 102 extend a lesser distance into contact or near contact with the user's cheek and eyebrow region. Although a single protrusion is depicted, other embodiments may include any number of protrusions, indentations, or similar curvatures. These protrusions, indentations, and curvatures may substantially conform to the shape of a user's face during use. For example, in the above described embodiment, additional curvature/indentation of contact edge 130 proximate to first end 142 may be provided to account for curvature of a user's cheek.

Shield 102 may be formed or cut to a shape that is similar to the shape of frames 104, rims 108, and/or channel 122. In some embodiments, insertion edge 128 that couples to frames 104 includes a curvature that is complementary to a curvature of frames 104, rims 108, and/or channel 122. For example, in the illustrated embodiment, insertion edge 128 includes two areas of curvature. Such a curvature may be complementary to curvatures in top member 108a and bottom member 108b that are curved to wrap around a user's face, for instance. In some embodiments, insertion edge 128 may include a flat/straight edge, as indicated by dashed line 128a. Such a flat edge may be conducive for use with frames 104 and rims 108 that are substantially planar, and do not have much or any curvature. For example, where inner surfaces 123 of frames 104/rims 108 are located in a common plane without much or any curvature out of the plane.

Shield 102 may include various other features including but not limited to those described herein. In the illustrated embodiment, shield 102 includes expansion feature 132, similar to those described with respect to FIGS. 5A and 5B. As depicted, expansion features 132 run along a length of shield 102, and are oriented substantially parallel to insertion edge 128. In the illustrated embodiment, expansion features 132 run only a portion of the length of shield 102; however, other embodiments may include expansion features 132 running the entirety of the length of shield 102 (e.g., from first end 142 to second end 144). Further, the illustrated embodiment includes vent holes 146 cut into certain portions of shield 102. In certain situations, vent holes may be desirable to regulate or facilitate airflow through the eye region. In some embodiments, vent holes may increase comfort by allowing sufficient airflow to regulate temperature at the eye region or to prevent fogging of the lenses. In the illustrated embodiment, a series of vent holes are provided proximate to first end 142, second end 144, and a central portion of shield 102. Other embodiments may include any number of vent holes at various other locations, or no vent holes. Moreover, the vent holes may be of any shape desired, e.g., circular, oval, rectangular, etc. For example, in some embodiments, the vent holes may be slits, or have more complex shapes, as desired. Additionally, in some embodiments, the vent holes may be positioned to facilitate air flow in a specified manner. For example, vent holes may be provided at the bottom and top of the moisture chamber to promote convection, i.e., allowing warmer air to exit at the top, and cooler air to enter at the bottom.

In the illustrated embodiment, shield 102 includes a slit 148. In some embodiments, slit 148 may be formed in shield 102 such that when shield 102 is installed on the frames, it provides a location for the arms of the eyeglasses to be folded without bending or otherwise undesirably deforming shield 102. For example, in the illustrated embodiment, slit 148 includes a linear slit 148a that extends from contact edge 130 to a small circular cut 148b in a central region of shield 102. Slit 148 is located such that when shield 102 is installed into the frames it substantially aligns with arms of the eyeglasses, thereby allowing the arms to be folded into slit 148. When completely folded, the arms may rest in cut 148b. Such an arrangement enables shield 102 to remain substantially erect, and reduces the likelihood of bending of shield 102 that may lead to undesirable creasing. Other embodiments may include any number and configuration of slits.

In the illustrated embodiment, shield 102 also includes preformed creases 150. Preformed creases 150 may encourage bending of shield 102 at predetermined locations. For example, when eyeglasses 100 are set down or placed in a pocket (or case) for storage, the external forces on shield 102 may cause bending at the location of creases 150, as opposed to other unknown and potentially undesirable locations that could otherwise affect performance. In the illustrated embodiment, four creases 150 are depicted at protrusion 140. Other embodiments may include any number of creases at various locations in shield 102.

Shield 102 may include multiple portions that are affixed to one another. For example, shield 102 may include a portion that couples to and extends from frames 104, rims 108, and/or channel 122 rearward toward a user's face during use, another portion coupled to the first portion that extends rearward toward a user's face during use, and/or another portion that couples to one of the other portions and extends into contact or near contact with a user's face during use. In other words, the portions may be coupled in series to one another between frames 104 and a user's face during use. Such embodiments may enable custom cut portions of shield 102 to be coupled with common or standard sized/shaped portions of shield 102. For example, a portion of shield 102 that couples to frames 104, rims 108, and/or channel 122, or that contacts a user's face, may include a custom cut curvature based on the specific curvature of frames 104, rims 108, channel 122, and/or the shape of a person's face where shield 102 is to be used, and another portion of shield 102 may include a common or standard cut of shield material that is coupled to the custom portion of shield 102. Such an embodiment may help to reduce cost and complexity be enabling one portion of shield 102 to be custom cut/fit while other portions are provided from common types and/or shapes of materials. For example, one portion may include a first type of material that is rigid (e.g., stiff), and another portion contacting the user's face may be formed from a less rigid (e.g., softer) material that is more comfortable to a user when it contacts the user's face. Further, a manufacturer may be able to vary the uses or configurations of the shield by simply changing the configuration (e.g., the shape) of only a portion of shield 102, as opposed to having to cut a single shield to include curvature for frames 104, rims 108, channel 122, and/or the user's face.

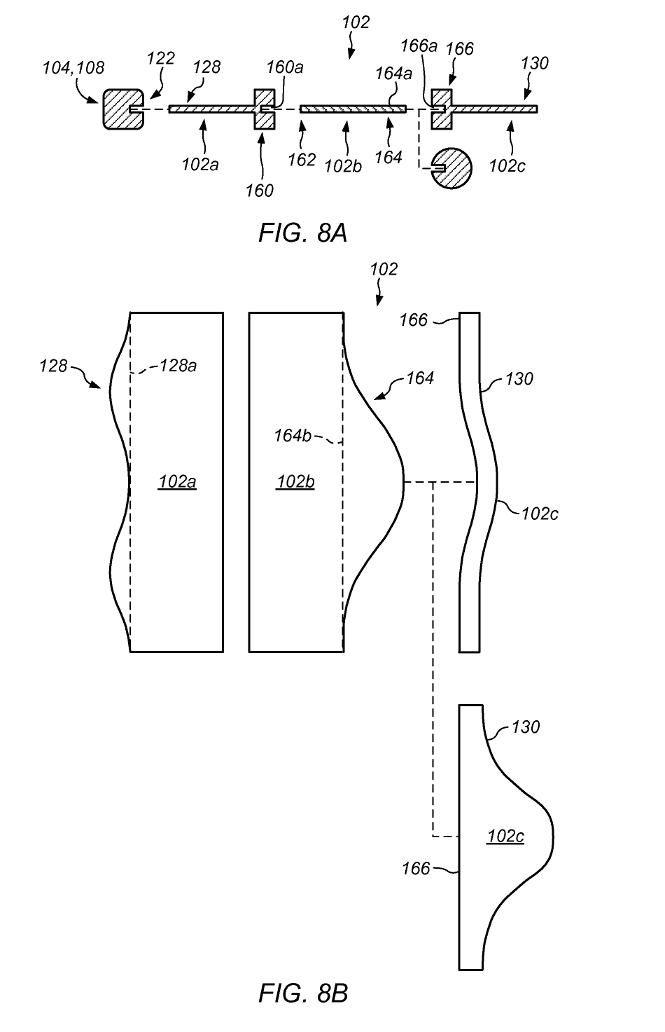

FIGS. 8A and 8B illustrate exemplary embodiments of third shield portion 102c. FIG. 8A illustrates a cross-sectional view of shield 102 having multiple portions in accordance with one or more embodiments of the present technique. FIG. 8B illustrates a top-view of a flattened shield 102 of FIG. 8A. In the illustrated embodiment, shield 102 includes a first shield portion 102a, a second shield portion 102b, and a third shield portion 102c. During use, first shield portion 102a may be disposed proximate to frames 104, third shield portion 102c may be disposed proximate to a user's face, and second shield portion 102b may be disposed between first shield portion 102a and third shield portions 102c.

First shield portion 102a may couple directly to frames 104, rims 108, and/or channel 122. For example, in some embodiments, first shield portion 102a includes insertion edge 128 that couples to frames 104 and rims 108 via channel 122 as described herein. Insertion edge 128 of first shield portion 102a may include various features, such as engagement features described herein, to facilitate coupling of insertion edge 128 to frames 104, rims 108, and/or channel 122.

In some embodiments, insertion edge 128 includes a curvature that is complementary to a curvature of frames 104, rims 108 and/or channel 122. For example, in the illustrated embodiment, insertion edge 128 includes two areas of curvature. Such a curvature may be complementary to curvatures in top member 108a and bottom member 108b that are curved to wrap around a user's face, for instance. Insertion edge 128 may include various curvatures and shapes that are conducive to mating with frames 104, rims 108, and/or channel 122. In some embodiments, insertion edge 128 may include a flat/straight edge, as indicated by dashed line 128a. Such a flat insertion edge 128a may be conducive for use with frames 104, rims 108, and/or channel 122, that are substantially planar, and do not have much or any curvature. For example, where inner surfaces 123 are located in a common plane without much or any curvature out of the plane.

In some embodiments, a rear edge 160 of first shield portion 102a is couplable to a front edge 162 of second shield portion 102b. In the illustrated embodiment, rear edge 160 and front edge 162 include complementary mating features that enable them to be coupled to one another. Rear edge 160 includes a slot/channel 160a and front edge 162a includes a flat edge that may be slid or snapped into slot/channel 160a. Slot/channel 160a and front edge 162a may include engagement features similar to those descried with respect to insertion edge 128 and channel 122. In some embodiments, rear edge 160 and front edge 162 may be coupled via interference fit, ultrasonic welding, an adhesive, interlocking parts, or the like.

In some embodiments, rear edge 160 and front edge 162 are complementary shaped (e.g., have the same shape) such that first shield portion 102a and second shield portion 102b can be coupled to one another along an entirety of their length. For example, both rear edge 160 and front edge 162 may include a substantially straight edge as depicted in FIG. 8B. Other embodiments may include various curvatures. A substantially straight edge may result in a flat contoured cylindrical-type rear edge 160 when first shield portion 102a is installed/coupled to frames 104, rims 108, and/or channel 122. Such a flat contoured cylindrical type edge may simplify shaping and attachment of second shield portion 102b because a straight/flat front edge 162 may be cut and coupled to rear edge 160.

In some embodiments, rear edge 164 of second shield portion 102b and front edge 166 of third shield portion 102c are complementary shaped (e.g., have the same or similar shape) such that first shield portion 102a and second shield portion 102b can be coupled to one another along an entirety of their length. For example, rear edge 164 may include a curved edge, or a substantially straight edge (as depicted by the solid and dashed lines, respectively, of second shield portion 102b in FIG. 8B, and front edge 166 may be shaped similarly or conformable to the shape of rear edge 164. In one of the illustrated embodiments, third shield portion 102c includes a strip/piping that, although generally straight, may be bent/conformed to fit over rear edge 164. In another of the illustrated embodiments, third shield portion 102c includes a straight edge of a sheet, as depicted by dashed line 164b, that is complementary to the straight rear edge 164. A substantially straight edge may result in a flat contoured cylindrical-type rear edge 164 when second shield portion 102b is installed. Such a flat contoured cylindrical type edge may simplify shaping and attachment of third shield portion 102c because a straight/flat front edge 166 may be cut and coupled to rear edge 164. In the illustrated embodiment, third shield portion 102c includes a contact edge 130 that is curved to conform to the curvature of a user's face, similar to that described above with respect to FIG. 7.

In some embodiments, a rear edge 164 of second shield portion 102b is capable of coupling to a front edge 166 of third shield portion 102c. In the illustrated embodiment, rear edge 164 and front edge 166 include complementary mating features that enable them to be coupled to one another. Front edge 166 includes a slot/channel 166a and rear edge 164a includes a flat edge that may be slid or snapped into slot/channel 166a. Slot/channel 166a and rear edge 164a may include engagement features similar to those described herein with respect to insertion edge 128 and channel 122. In some embodiments, rear edge 160 and front edge 162 may be coupled via interference fit, ultrasonic welding, an adhesive, interlocking parts, or the like.

In some embodiments, first shield portion 102a includes a sheet of flexible material, a rigid material, a transparent material, an opaque material, or any combination thereof. First shield portion 102a may include features similar to those described above with respect to FIGS. 4A-7. In some embodiments, second shield portion 102b may include a sheet of material that extends toward a user's face when front edge 162 is coupled to first shield portion 102a, frames 104, rims 108, and/or channel 122. In some embodiments, second shield portion 102b may include a flexible material, a rigid material, a transparent material, an opaque material, or any combination thereof. Second shield portion 102b may include features similar to those described above with respect to FIGS. 4A-7. In some embodiments, third shield portion 102c may include a sheet of material that extends toward a users face when front edge 166 is installed.

In some embodiments, third shield portion 102c may include an extension of material that abuts a user's face. For example, additional width of a sheet of material may extend from rear end 164a to contact edge 102. In some embodiments, third shield portion 102c may include a component that is coupled to rear edge 164a to enhance comfort to a user. For example, in one of the illustrated embodiments, third shield portion 102c includes a generally round shaped lip (e.g., piping) that can be coupled to rear edge 164a. In some embodiments, third shield portion 102c may be replaceable such that a user can exchange third shield portion 102c for a desired shape and/or replace third shield portion 102c when it becomes worn or is no longer suitable for use. In some embodiments, third shield portion 102c may include a flexible material, a rigid material, a transparent material, an opaque material, or any combination thereof. Third shield portion 102c may include features similar to those described above with respect to FIGS. 4A-7.

In some embodiments, shield 102 may include any number of portions. Shield 102 may include any combination of first and second portions 102a, 102b, and 102c. For example, shield 102 may include only first and second shield portions 102a and 102b, first and third shield portions 102a and 102c, second and third shield portions 102b and 102c. Moreover, in some embodiments, one or more additional portions may be used as desired.

Eyeglasses 100 and shield 102 may be formed and manufactured by any number of processes. For example, in some embodiments, a user may be provided a pre-assembled pair of eyeglasses that includes a shield already attached thereto. In some embodiments, the shield may be preformed/precut to fit the user's eye region. In another embodiment, the shield may include a generic shape that may need to be further altered to conform to their eye region. Further, certain embodiments may include providing one or more shields separate from the frames such that a user may need to attach the shield to the frames. Such an embodiment may help to simplify sizing and modifying of the shield as the user may be able to trim the shield while it is laid out in a substantially flat orientation. Still, in other embodiments, a sizing method may be employed such that a manufacture or user can determine the shape of their face, and have the shield pre-cut based on the determined shape. In a further embodiment, multiple shield portions (e.g., portions 102c) may be provided from which the user may select one that best fits the user's face.

FIG. 9 is a flowchart that illustrates a method 300 of manufacturing eyeglasses, in accordance with one or more embodiments of the present technique. In the illustrated embodiment, method 300 includes sizing the shield, as depicted at block 302. In some embodiments, sizing the shield may include a manufacturer selecting a certain shield size based on the frames to be used or an intended user. For example, in some embodiments, a manufacturer may select a shield size and/or shape based on the type, style and/or shape or a particular type of frame to be used. In some embodiments, a manufacturer may have access to additional information, such as sizing information relating to the intended user. For example, in a generic situation, the manufacturer may select a certain size (e.g., small, medium, or large) shield size based on the size of an intended user. Further, in some embodiments, the manufacturer may even receive specific information relating to the intended user. For example, a user may inform the manufacture that they have a small, medium or large face size. In yet another embodiment, a user may provide information relating to the actual size and shape of their face. For example, a user may be custom fitted such that specific curves of a contact edge of the shield are specified. In one instance, a user may be fitted by an optometrist. In another instance, the manufacture may provide a fitting kit, such as a fitting sheet that can be cut or shaped by a user to their desired fit. The resulting fit information may be provided to the manufacturer, and used by the manufacture for determining how to cut of the actual shield to be installed. For example, the manufacture may provide a generic sheet having roughly the desired shape, and the user may measure and cut the final desired shape to be used by the manufacture. Other similar techniques may be employed. For example, a user may simply assess the size of their own face such that they can purchase an appropriate sized shield and/or cut the shield to a final shape. Such an approach may be well suited when a user is sizing, forming, and installing the shield themselves. In another embodiment, a user's face may be scanned or otherwise measured to provide a 3 dimensional model of relevant portions of the user's face for use by the manufacturer in sizing/shaping the shield or shield portion(s).

In the illustrated embodiment, method 300 includes forming the shield, as depicted at block 304. In some embodiments, forming the shield (block 304) may include extruding, molding, cutting, or otherwise forming features of the shield. For example, in some embodiments, forming the shield may include extruding a sheet of material used to form the shield. In some embodiments, forming the shield includes forming/cutting the shield to an appropriate shape and forming any additional desired features. For example, in some embodiments, an outline of the shield (e.g., including an insertion edge, contact edge, leading end and trailing end) may be cut based on the size information gathered during sizing of the shield at block 302. In one embodiment, an outline may be cut into a piece of flat material such that it includes a protrusion or similar curvatures conducive to sealing to a user's face. In some embodiments, other features may be formed. For example, expansion features, vent holes, slits, creases and the like may be formed in the shield. In some embodiments, forming the shield may include coupling a plurality of shield portions to one another and/or frames, rims, or a channel.

In the illustrated embodiment, method 300 also includes forming the frames, as depicted at block 306. In some embodiments, forming the frames includes forming frames that include a shield mount. In some embodiments, the frames are formed to include a shield mount integrally formed into the frames. For example, frames may be extruded or molded with a channel or similar shield mount formed therein. In some embodiments, frames may be formed without a channel or a similar shield mount formed therein, and a subsequent milling or cutting may be performed to form the channel as an integral portion of the frames. Such an embodiment may enable retrofit of existing frames that were not provided with such a shield mount.

In some embodiments, forming the frames may include providing a shield mount that is not integral with the frames. For example, in some embodiments, forming the frames includes attaching a shield mount to the frames. In some embodiments, attaching the shield mount includes coupling a separate member to the frames. For example, the shield mount may include a channel formed therein, and the shield mount may be attached to the frames (e.g., a rim of the frames) via an adhesive, a mechanical fastener, soldering, ultrasonic welding, interlocking parts, or the like. Such an embodiment may enable retrofit of existing frames that were not provided with such a shield mount.

In the illustrated embodiment, method 300 also includes installing the shield, as depicted at block 308. In some embodiments, installing the shield includes coupling or otherwise affixing the shield to the eyeglass frames. For example, in some embodiments, an insertion edge of the shield may be slid or snapped into a channel of the shield mount. In some embodiments, installing the shield may include coupling the shield to the shield mount via an adhesive, a mechanical fastener, soldering, ultrasonic welding, interlocking parts, or the like. In some embodiments, installing the shield may include additional trimming of the shield to provide a sufficient fit to a user's face and eye region. In some embodiments, installing the shield may include coupling a plurality of shield portions to one another and/or frames, rims, or a channel.

The above described embodiments may enable a user to receive or prepare a pair of eyeglasses that are suitable for retaining moisture around the user's eye region(s) and/or prevent airborne debris from entering the eye region(s). Further certain embodiments may include methods, elements, or techniques that further increase the flexibility and enhance the use of the eyeglasses. For example, in some embodiments, once a size (and/or shape) of the shield and/or desired features are determined, multiple shields may be formed such that the size of the shield does not have to be reassessed each time a user wishes to replace the shield. For example, a manufacture can form multiple shields and provided them to the user such that the user is able to replace the shields as needed.

Although the embodiments above have been described in considerable detail, numerous variations and modifications will become apparent to those skilled in the art once the above disclosure is fully appreciated. It is intended that the following claims be interpreted to embrace all such variations and modifications. Other embodiments may include various modifications and alterations that still fall within the scope of the contemplated embodiments. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. The words “include”, “including”, and “includes” mean including, but not limited to. As used herein, the singular forms “a”, “an” and “the” include plural referents unless the content clearly indicates otherwise. Thus, for example, reference to “a device” includes a combination of two or more devices.

What is claimed is:

1. An eyewear shield, comprising:
a shield configured to be coupled to an eyeglass frame, the shield comprising:
a sheet of material configured to extend between the eyeglass frame and a user's face during use, wherein the sheet of material comprises;
an insertion edge configured to couple to a shield mount channel of the eyeglass frame; and
a contact edge configured to be in contact or in near contact with a user's face during use;
wherein the shield is configured to inhibit the evaporation of moisture from a user's eye region during use.

2. The eyewear shield of claim 1, wherein the sheet of material is transparent.

3. The eyewear shield of claim 1, wherein at least a portion of the insertion edge is configured to be inserted into a channel of the shield mount.

4. The eyewear shield of claim 1, wherein the insertion edge comprises a protrusion configured to be inserted into the shield mount channel.

5. The eyewear shield of claim 1, wherein the insertion edge comprises a shape that is substantially complementary to a shape of the shield mount channel.

6. The eyewear shield of claim 1, wherein the insertion edge comprises at least one of:
a T-shaped lip;
an L-shaped lip;
a triangular-shaped lip;
an arrow-shaped lip; or
a circular-shaped lip.

7. The eyewear shield of claim 1, wherein the contact edge comprises a curved portion configured to contact a user's face during use.

8. The eyewear shield of claim 1, wherein the contact edge comprises a curvature configured to conform to the curvature of a user's face during use.

9. The eyewear shield of claim 1, wherein the sheet of material comprises an expansion feature configured to expand and contract the shield between the eyeglass frames and a user's face during use.

10. The eyewear shield of claim 1, wherein the shield comprises multiple shield portions configured to be coupled to one another in series between eyeglass frames and the user's face during use.

11. The eyewear of claim 1, wherein the shield mount channel comprises a channel along an interior edge of the eyeglass frame configured to retain an edge of an eyeglass lens.

12. The eyewear of claim 1, wherein the sheet of material comprises an insertion edge configured to be coupled between the eyeglass frame and an eyeglass lens, wherein the sheet of material comprises a protrusion configured to engage the shield mount channel, and a lens mount channel configured to retain the eyeglass lens during use.

13. An eyewear shield system, comprising:
an eyeglass frame, comprising:
a rim configured to secure an eyeglass lens, wherein the rim comprises an internal face configured to face a user during use; and
a shield mount comprising a channel that extends along at least a portion of the internal face of the rim, wherein the channel is configured to receive an insertion edge of an eyewear shield configured to inhibit the evaporation of moisture from a user's eye region during use.

14. The eyewear shield system of claim 13, wherein the channel comprises a first channel portion having walls separated by a first width, and a second channel portion having walls separated by a second width, wherein the second width is greater than the first width, and wherein the first channel portion and the second channel portion are adjacent one another such that at least a portion of the first channel portion and the second channel portion are in communication with one another.

15. The eyewear shield system of claim 14, wherein at least one end of the first channel portion terminates into the second channel portion to form a channel loop.

16. The eyewear shield system of claim 14, wherein the second channel portion is configured to enable the insertion edge to be passed there through and slid into an adjacent portion of the first channel portion, and wherein the first channel portion is configured to retain the eyewear shield during use.

17. The eyewear shield system of claim 13, wherein the channel comprises an internal slot portion proximate to an interior region of the shield mount and an external slot portion proximate to an exterior surface of the shield mount, wherein the internal slot portion and the external slot portion are in communication with one another, and wherein the external slot portion comprises a narrow width that defines a necked portion of the channel configured to retain an insertion edge of the eyewear shield.

18. The eyewear shield system of claim 13, wherein the channel comprises at least one of:
a T-shaped slot.
an L-shaped slot;
a triangular-shaped slot;
an arrow-shaped slot; or
a circular-shaped slot.

19. The eyewear shield system of claim 13, wherein the shield mount comprises a channel that is integral with the rim.

20. The eyewear shield system of claim 13, wherein the shield mount comprises a structure coupled to the rim.

21. The eyewear shield system of claim 13, further comprising the eyewear shield, wherein the eyewear shield comprises an insertion edge configured to be inserted into the channel of the shield mount.

22. The eyewear shield of claim 13, wherein the shield mount comprises an insert configured to be coupled between an interior edge of the rim and an external edge of a lens during use.

23. An eyewear shield system, comprising:
an eyeglass lens comprising a magnetic portion; and
a shield mount comprising a complementary magnetic portion configured to magnetically couple to the magnetic portion during use, wherein the shield mount comprises a channel configured to receive an insertion edge of an eyewear shield configured to inhibit the evaporation of moisture from a user's eye region during use.

24. A method, comprising:
forming an eyewear shield comprising an insertion edge configured to be coupled to a channel of an eyeglass frame;
forming a channel into an eyeglass frame, wherein the channel extends around at least a portion of a rim of the eyeglass frame; and
coupling the insertion edge to the channel.
